(19) United States
(12) Patent Application Publication
(10) Pub. No.: US 2014/0049482 A1
(43) Pub. Date: Feb. 20, 2014

(54) TOUCH DETECTION STRUCTURE AND TOUCH DISPLAY DEVICE USING SAME

(71) Applicant: Chiu-Mao Huang, New Taipei City (TW)

(72) Inventor: Chiu-Mao Huang, New Taipei City (TW)

(21) Appl. No.: 13/589,677

(22) Filed: Aug. 20, 2012

(51) Int. Cl. G06F 3/041

(52) U.S. Cl. 345/173

(57) ABSTRACT

A touch detection structure and a touch display device using same are disclosed. The touch detection structure includes a frame, a plurality of transmitters, and a plurality of receivers. A printed circuit layer is directly formed on one surface of the frame by way of mechanical processing to electrically connect to the transmitters and the receivers. With the printed circuit layer being directly formed on the frame of the touch detection structure, the touch display device using such touch detection structure can save the costs for using and manufacturing circuit boards and has reduced overall thickness to enable convenient assembling thereof.

### FIELD OF THE INVENTION

The present invention relates to a touch detection structure, and more particularly to a touch detection structure having a printed circuit layer directly formed on a frame thereof, so that the cost for using a circuit board is saved and the overall thickness of the touch detection structure is reduced to enable convenient assembling thereof. The present invention also relates to a touch display device using the above-described touch detection structure.

### BACKGROUND OF THE INVENTION

Thanks to the constant progress in various technical fields, many currently available electronic products are very small in volume but equipped with a large-size screen. The large-size screen, however, inevitably occupies the space on the electronic product for operating buttons. To enable normal operation of the large-size screen without physical operating buttons, various types of touch screens have been developed and consumers' demands for touch screens quickly increase.

Currently, the most popular large-size touch screens are infrared touch screens. According to the basic structure of an infrared touch screen, a plurality of transmitters and a plurality of receivers are mounted along outer edges of a screen panel in a predetermined sequence. The transmitters and the receivers are arranged in one-to-one correspondence to form an infrared grid consisting of two transmitter-receiver arrays perpendicular to one another. Under the control of a processor, the corresponding transmitters and receivers are electrically connected in a predetermined sequence for detecting whether the infrared beams between the corresponding transmitter-receiver pairs are interrupted, so as to determine whether the touch screen is touched by an object.

FIG. 1 shows a conventional touch detection device 1 for touch panel. The touch detection device 1 includes a frame 10, on one surface of which a plurality of circuit boards 11 is provided. The circuit boards 11 are located on a plurality of frame members of the frame 10. A plurality of transmitters 111, a plurality of receivers 112, and a plurality of electronic elements 113 are arranged on the circuit boards 11. The transmitters 111 and the receivers 112 are arrayed in a predetermined manner to form an infrared touch matrix. Under the control of the electronic elements 113, the correspondingly arrayed transmitter-receiver pairs 111, 112 are electrically connected in a predetermined sequence for detecting whether the infrared beams between the transmitter-receiver pairs are interrupted, so as to determine whether the touch panel is touched by an object. The conventional touch detection device 1 must have a plurality of circuit boards 11 provided on the frame 10, and these circuit boards 11 must be electrically connected to one another. Therefore, additional costs for using and manufacturing the circuit boards 11 are required. These circuit boards 11 mounted on the frame 10 also increase an overall thickness of the touch detection device 1, rendering the touch panel using the touch detection device 1 inconvenient for assembling.

In brief, the conventional touch detection device for a touch panel has the following disadvantages: (1) requiring additional costs for using and manufacturing circuit boards; (2) having large overall thickness; and (3) being inconvenient for assembling.

It is therefore tried by the inventor to develop an improved touch detection structure and a touch display device using same to overcome the above problems.

### SUMMARY OF THE INVENTION

A primary object of the present invention is to solve the problems in the conventional touch detection device by providing an improved touch detection structure that has a printed circuit layer directly formed on a frame thereof to save the cost for circuit boards.

Another object of the present invention is to provide a touch display device that has reduced overall thickness and is more convenient for assembling.

To achieve the above and other objects, the touch detection structure according to the present invention includes a frame, a plurality of transmitters, and a plurality of receivers. The frame is formed of a first frame member, a second frame member, a third frame member and a fourth frame member. The first and the third frame member are correspondingly located at two opposite sides of the frame, while the second and the fourth frame member are correspondingly located at another two opposite sides of the frame. A printed circuit layer is directly formed on surfaces of the first, second, third and fourth frame members by way of mechanical processing. The transmitters and the receivers are arranged on the frame and electrically connected to the printed circuit layer. With the printed circuit layer being directly formed on the frame, the touch detection structure can save the costs for using and manufacturing circuit boards and has reduced overall thickness to enable convenient assembling thereof.

To achieve the above and other objects, the touch display device according to the present invention includes a case, a display panel, and a frame. The case internally defines a receiving space for receiving the display panel therein. The display panel has a display surface corresponding to an opening of the receiving space. The frame is assembled to the case to locate over one side of the display panel having the display surface. The frame is formed of a first, a second, a third, and a fourth frame member; the first and the third frame member are correspondingly located at two opposite sides of the frame while the second and the fourth member are correspondingly located at another two opposite sides of the frame. A printed circuit layer is directly formed on surfaces of the first, second, third and fourth frame members. A plurality of transmitters and a plurality of receivers are arranged on the frame and electrically connected to the printed circuit layer. The transmitters and receivers are located on one face of the frame oriented toward the display surface of the display panel. By directly forming the printed circuit layer on the frame, the touch display device can save the costs for using and manufacturing circuit boards, and has reduced overall thickness to enable convenient assembling thereof.

Therefore, the present invention provides the following advantages: (1) saving the costs for using and manufacturing circuit boards; (2) having reduced overall thickness; and (3) being more convenient for assembling.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional touch detection device for touch panel;

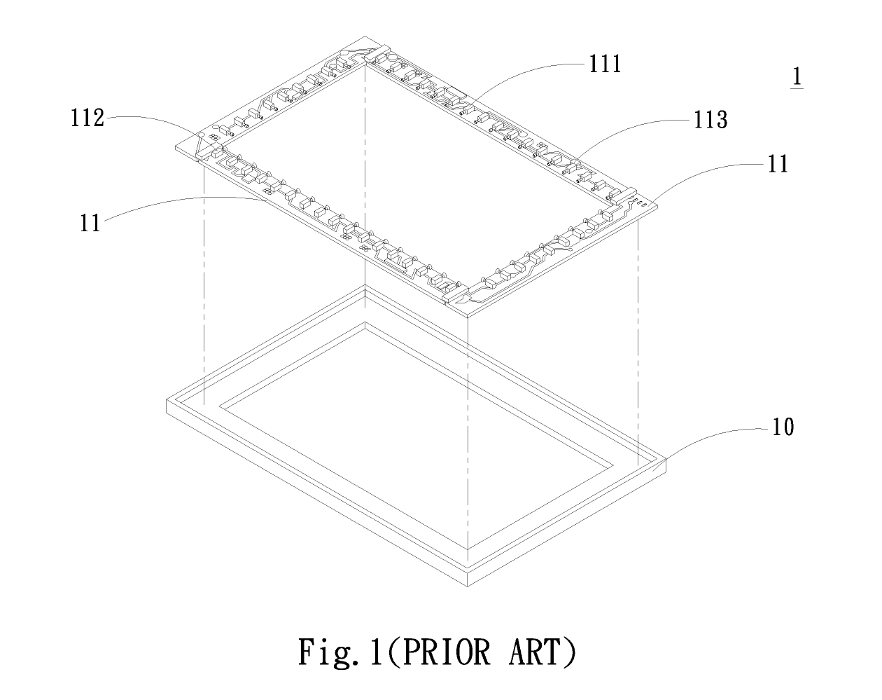

FIG. 2 is a perspective view of a touch detection structure according to a first preferred embodiment of the present invention;

FIG. 3 is a top plan view of FIG. 2;

FIG. 4 is a perspective view of a touch detection structure according to a second preferred embodiment of the present invention;

FIG. 5 is a top plan view of FIG. 4;

FIG. 6 is an exploded perspective view of a touch display device according to a preferred embodiment of the present invention; and

FIG. 7 is a cutaway view of the touch display device according to the preferred embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

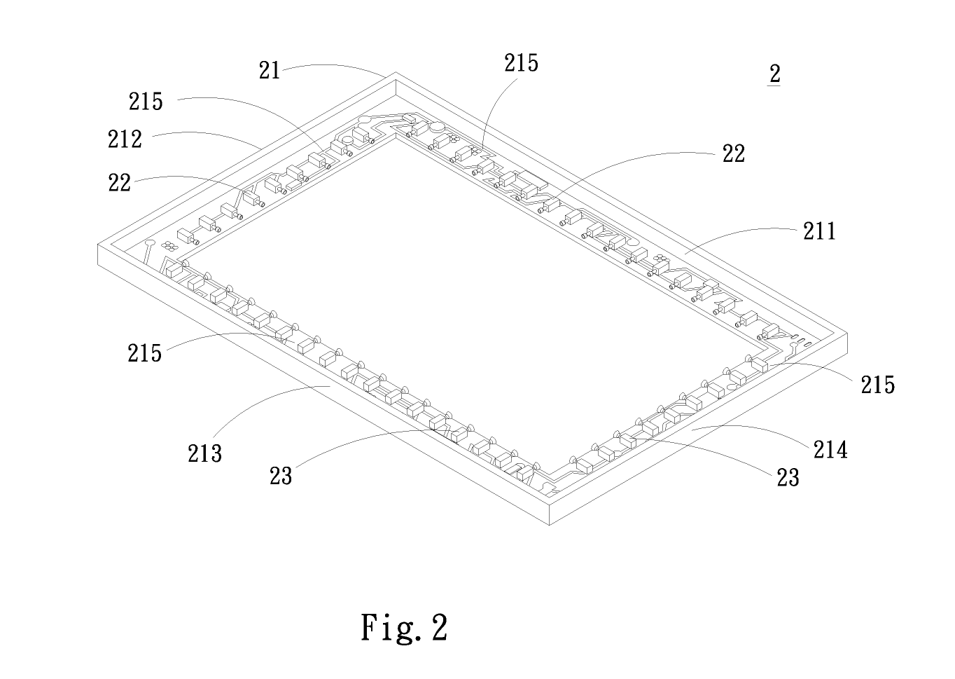

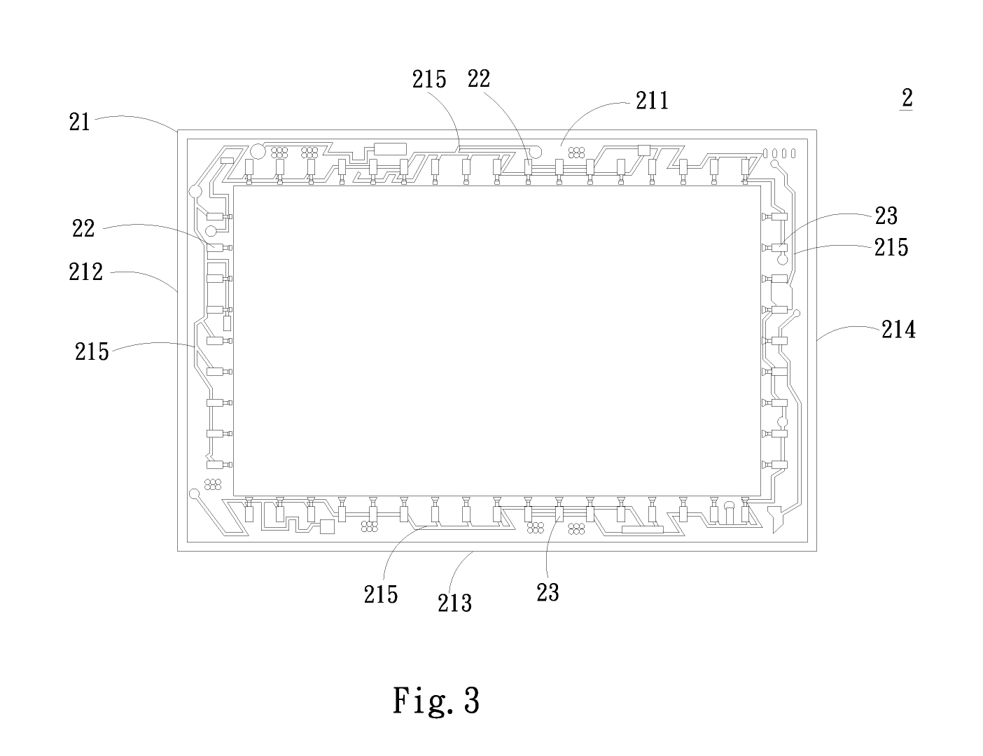

Please refer to FIGS. 2 and 3 that are perspective and top plan views, respectively, of a touch detection structure 2 according to a first preferred embodiment of the present invention. As shown, the touch detection structure 2 in the first embodiment includes a frame 21, a plurality of transmitters 22, and a plurality of receivers 23.

The frame 21 is formed of a first frame member 211, a second frame member 212, a third frame member 213, and a fourth frame member 214. The first and the third frame member 211, 213 are correspondingly located at two opposite sides of the frame 21, while the second and the fourth frame member 212, 214 are correspondingly located at another two opposite sides of the frame 21. A printed circuit layer 215 is directly formed on the surfaces of the first, second, third and fourth frame members 211, 212, 213, 214 by way of mechanical processing.

The mechanical processing can be screen printing, laser sculpturing, or any other suitable way for forming electric circuits.

The transmitters 22 and the receivers 23 are arranged on opposite sides of the frame 21 and are electrically connected to the printed circuit layer 215. In the illustrated first preferred embodiment, the transmitters 22 and the receivers 23 are configured as infrared transmitters and infrared receivers, the transmitters 22 are arranged on the first frame member 211 and the second frame member 212, and the receivers 23 are arranged on the third frame member 213 and the fourth frame member 21. However, it is understood the arrangements of the transmitters 22 and the receivers 23 are not necessarily limited to the above-described manners. For example, the transmitters 22 can be otherwise arranged on the third and the fourth frame member 213, 214 while the receivers 23 can be otherwise arranged on the first and the second frame member 211, 212.

In the first preferred embodiment, the transmitters 22 arranged on the first frame member 211 and the receivers 23 arranged on the third frame member 213 form two parallelly spaced rows on the same horizontal plane, and the transmitters 22 arranged on the second frame member 212 and the receivers 23 arranged on the fourth frame member 214 form another two parallelly spaced rows on the same horizontal plane. Further, the transmitters 22 on the first frame member 211 are correspondingly aligned with the receivers 23 on the third frame member 213, while the transmitters 22 on the second frame member 212 are correspondingly aligned with the receivers 23 on the fourth frame member 214. With these arrangements, the touch detection structure 2 not only achieves the touch detection purpose, but also saves the costs for using and manufacturing circuit boards. Moreover, by directly forming the printed circuit layer 215 on the frame 21, the touch detection structure 2 can have reduced overall thickness and can be more conveniently assembled.

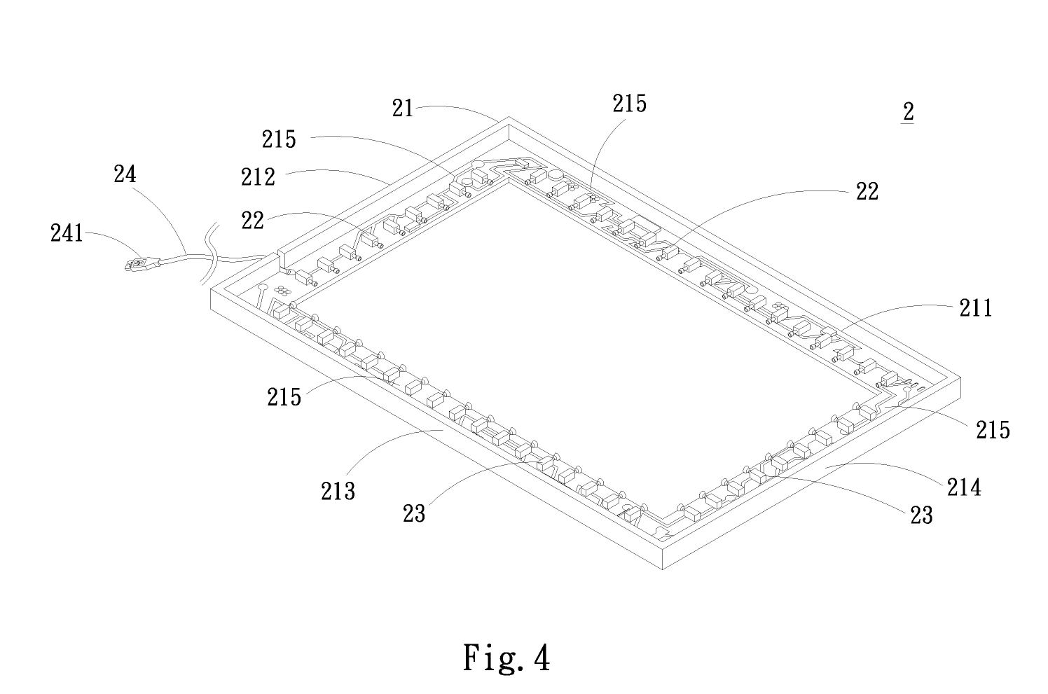

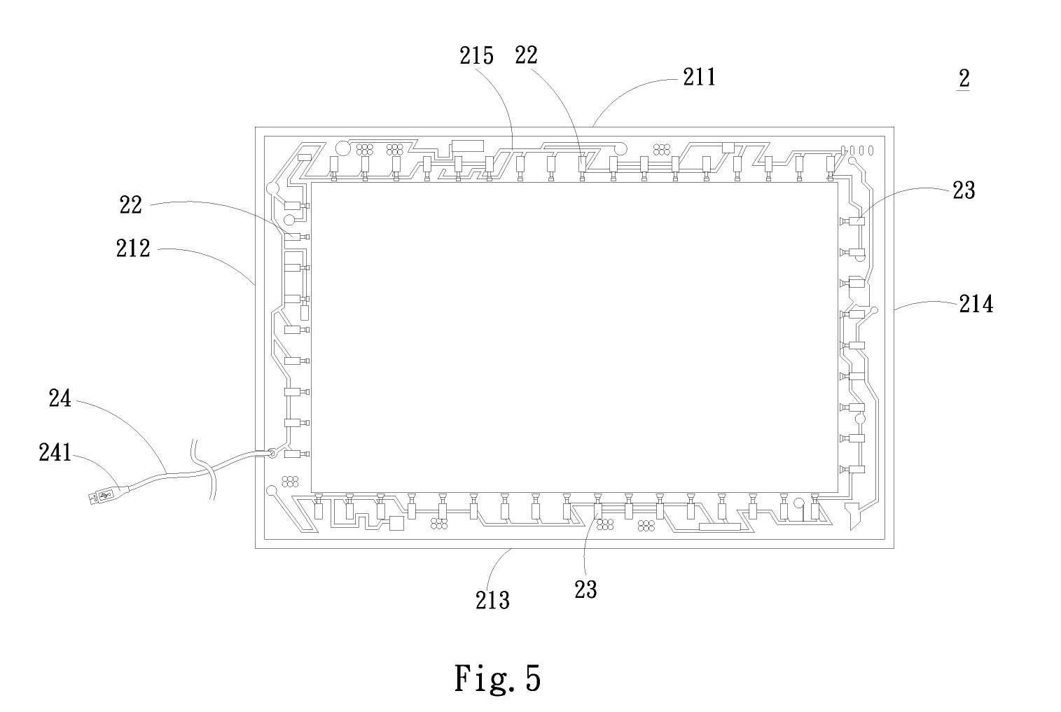

FIGS. 4 and 5 are perspective and top plan views, respectively, of a touch detection structure 2 according to a second preferred embodiment of the present invention. As shown, the touch detection structure 2 in the second preferred embodiment is generally structurally similar to the first preferred embodiment, except that, in the second preferred embodiment, the transmitters 22 on the first frame member 211 and the receivers 23 on the third frame member 213 are staggered from one another, while the transmitters 22 on the second frame member 212 and the receivers 23 on the fourth frame member 214 are also staggered from one another. With these arrangements, split light beams produced by the transmitters 22 can be correspondingly projected to the receivers 23 staggered from the transmitters 22 to obtain an increased range of detection light path thereof. Further, with the printed circuit layer 215 directly formed on the frame 21, the touch detection structure 2 according to the second preferred embodiment can also save the costs for using and manufacturing circuit boards, and has reduced overall thickness to enable convenient assembling thereof.

The touch detection structure 2 in the second preferred embodiment further includes a connection line 24 electrically connected to the printed circuit layer 215, the transmitters 22 and the receivers 23. The connection line 24 has a plugging end 241, which can be a USB (Universal Serial Bus) connector, a 1394 connector, or a HDMI (High Definition Multimedia Interface) connector.

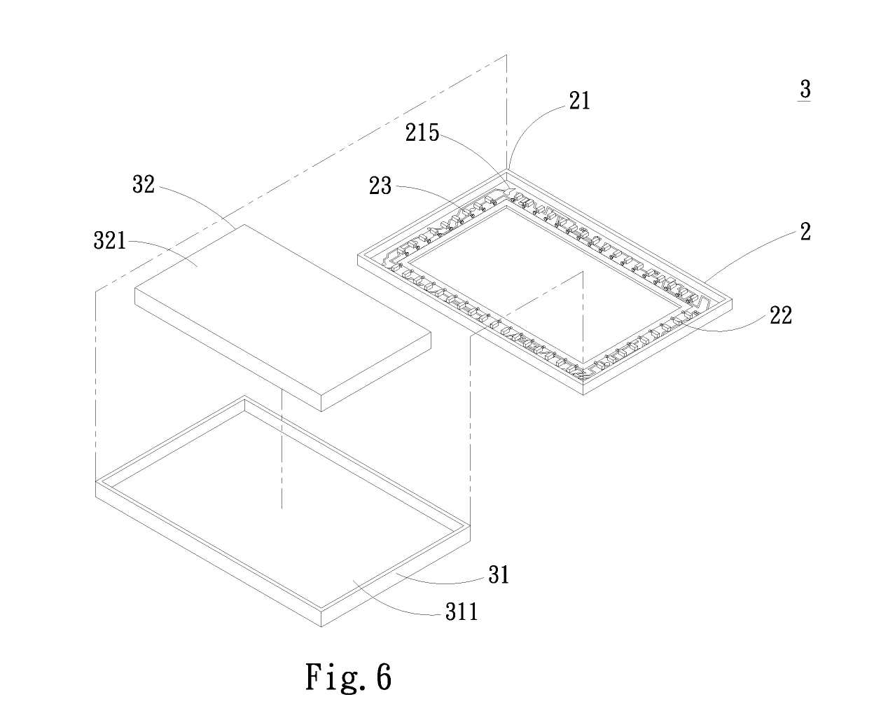

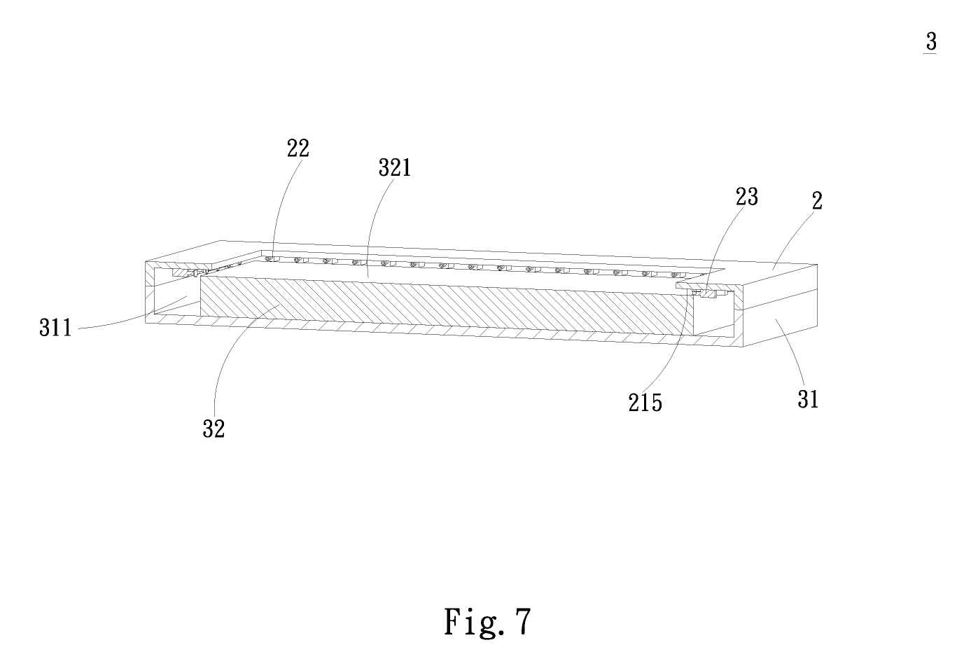

FIGS. 6 and 7 are exploded perspective view and cutaway view, respectively, of a touch display device 3 according to an embodiment of the present invention. As shown, the touch display device 3 employs the touch detection structure 2 according to the first preferred embodiment thereof. More specifically, the touch display device 3 includes a case 31, a display panel 32, and a frame 21. The case 31 internally defines a receiving space 311 for receiving the display panel 32 therein. The display panel 32 has a display surface 321. The frame 21 is assembled to the case 31 at a position corresponding to the display surface 321 of the display panel 32. The frame 21 is formed of a first frame member 211, a second frame member 212, a third frame member 213 and a fourth frame member 214. The first and the third frame member 211, 213 are correspondingly located at two opposite sides of the frame 21, while the second and the fourth frame member 212, 214 are correspondingly located at another two opposite sides of the frame 21. A printed circuit layer 215 is directly formed on the surfaces of the first, second, third and fourth frame members 211, 212, 213, 214 facing toward the display surface 321 to electrically connect to a plurality of transmitters 22 and a plurality of receivers 23 as well as a connection line 24. The transmitters 22 and receivers 23 are also provided on the surfaces of the first, second, third and fourth frame members 211, 212, 213, 214 facing toward the display surface 321 of the display panel 32, so that the transmitters 22 can transmit signals on the display surface 321 and the transmitted signals can be received by the receivers 23.

With the above structural design, the touch display device 3 can achieve the displaying function by touching it. Further, by directly forming the printed circuit layer 215 on the frame 21, the touch display device 3 can save the costs for using and manufacturing circuit boards, and has a reduced overall thickness to enable easy assembling thereof.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A touch detection structure, comprising:
a frame being formed of a first frame member, a second frame member, a third frame member and a fourth frame member, and including a printed circuit layer directly formed on surfaces of the first, second, third and fourth frame members on the same side thereof;
a plurality of transmitters being arranged on the frame and electrically connected to the printed circuit layer; and
a plurality of receivers being arranged on the frame and electrically connected to the printed circuit layer.

2. The touch detection structure as claimed in claim 1, wherein the transmitters are arranged on the first frame member and the second frame member.

3. The touch detection structure as claimed in claim 2, wherein the receivers are arranged on the third frame member and the fourth frame member.

4. The touch detection structure as claimed in claim 3, wherein the transmitters on the first frame member and the receivers on the third frame member are facing toward and correspondingly aligned with one another.

5. The touch detection structure as claimed in claim 3, wherein the transmitters on the second frame member and the receivers on the fourth frame member are facing toward and correspondingly aligned with one another.

6. The touch detection structure as claimed in claim 3, wherein the transmitters on the first frame member and the receivers on the third frame member are facing toward but staggered from one another.

7. The touch detection structure as claimed in claim 3, wherein the transmitters on the second frame member and the receivers on the fourth frame member are facing toward but staggered from one another.

8. The touch detection structure as claimed in claim 1, further comprising a connection line electrically connected to the printed circuit layer, the transmitters and the receivers; the connection line including a plugging end, and the plugging end being selected from the group consisting of a USB connector, a 1394 connector and an HDMI connector.

9. A touch display device, comprising:
a case internally defining a receiving space;
a display panel being received in the receiving space and having a display surface; and
a frame being assembled to the case; the frame being formed of a first frame member, a second frame member, a third frame member and a fourth frame member, and including a printed circuit layer directly formed on surfaces of the first, second, third and fourth frame members on the same side thereof; and the printed circuit layer being electrically connected to a plurality of transmitters, a plurality of receivers, and a connection line.

10. The touch display device as claimed in claim 9, wherein the printed circuit layer is formed on the surfaces of the first, second, third and fourth frame members on the side facing toward the case, and the frame is assembled to the case to locate over the display panel with the transmitters and the receivers correspondingly located on the display surface of the display panel.
